(19) United States
(12) Patent Application Publication
(10) Pub. No.: US 2019/0279267 A1
(43) Pub. Date: Sep. 12, 2019

(54) METHOD AND SYSTEM FOR DIRECT COMMUNICATIONS BETWEEN A CUSTOMER AND A MERCHANT SALESPERSON

(71) Applicant: Aashish Varma, Costa Mesa, CA (US)

(72) Inventor: Aashish Varma, Costa Mesa, CA (US)

(21) Appl. No.: 16/422,892

(22) Filed: May 24, 2019

Related U.S. Application Data
(63) Continuation of application No. 14/798,299, filed on Jul. 13, 2015, now abandoned.
(60) Provisional application No. 62/023,515, filed on Jul. 11, 2014.

(51) Int. Cl. G06Q 30/06

(52) U.S. Cl. CPC G06Q 30/0613

(57) ABSTRACT

A method to facilitate electronic communications between a customer and directly to one or more employees of a merchant is proved by the present method and system. A customer uses a computing device, such as an internet-enabled phone, to conduct a search. One or more merchant links are provided in one or both of a map form or a list, with communication links to one or more employees. The customer can enter a question or comment directed at a particular employee, after which, the employee has a time period in which she is capable of transmitting an answer or other response. If the time period expires, the customer question is forwarded to a second employee, who may also have a time period in which to reply. The customer can communicate simultaneously with one or more employees at one or more merchants.

### BACKGROUND

When a customer desires highly specific information regarding a particular product or service, they generally need to speak with the salesperson, employee, or other merchant who deals with that product or service on a daily basis. In many cases, this person is an employee salesperson working daily and exclusively within a particular department of a large store, such as the men's furnishings, women's shoes, men's or women's active wear, hosiery, and so on. To gain answers to specific questions, such as pricing, fit, styling, etc., the customer must either call or physically visit each store individually, find the appropriate department, and find a knowledgeable employee within that department. The quality and general knowledge of the employee may vary according to the day and time of the visit.

The current methods of direct communications between a customer and employee (or other merchant worker) present numerous hurdles for the average customer. First, the customer must find the local store phone number and contact information, and not the corporate or central contact information. Then, the customer must call the store, navigate through the automated system, and speak to an operator who transfers the call to the department. When a customer is comparison shopping or seeking the best answer to a query, this process must be repeated for each store within a neighborhood or given radius.

Some larger business have set up centralized instant messaging and call sites, where the customer can send a message to a call center or similar centralized customer service center. However, the message may not be answered appropriately or completely, because the general customer service representative may not be an expert for a particular department or product. Thus, these call centers lack the highly specific knowledge of a particular neighborhood and a specific product or department. Many of the interactions from call centers are scripted and non-personal. The customer exits the session feeling as if their questions and concerns were not addressed adequately.

What is needed is a system that permits easy and direct communication between a customer and employees at multiple store locations. What is also needed is a system that allows the customer to select a specific employee or a specific department with which to communicate, without navigating the store telephone or site menu.

### SUMMARY

The present system and software provides a method of facilitating communication between a user computing device and at least one of a first agent computing device and a second agent computing device, where the first agent computing device and the second agent computing device are each associated with one or more agents of a merchant, where the method operates under the control of one or more computing systems configured with executable instructions. A query regarding the merchant is communicated from the user computing device to the first agent computing device. A first response time period is initiated, within which a first query response can be received from the first agent computing device. The query is communicated to the second agent computing device upon expiration of the first response time period, and thereafter, a second query response can be received from the second agent computing device. At least one of the first query response and the second query response is communicated to the user computing device.

The present method may optionally include revoking an ability to communicate first query response upon expiration of the first response time period. Optionally, a second response time period can be initiated upon expiration of the first response time period, within which the second query response can be received from the second agent computing device. The query can be communicated to a third agent computing device upon expiration of the second response time period, thereafter a third query response can be received from the third agent computing device. Then, at least one of the first query response, the second query response, and the third query response is communicated to the user computing device.

The present method may optionally include receiving a search query from the user computing device entered into a search field of a user interface. The search result is caused to display on the user computing device, where the search result contains a communication link to the merchant. A communication link selection is received from the user computing device, where the communication link selection is associated with the communication link. A dialog field is caused to display user interface, so that the user can enter the query regarding the merchant. The server then receives the query regarding the merchant that is entered.

The search result may optionally contain a second communication link to a second merchant, where a fourth agent computing device is associated with the second merchant. As an option, the communication link of the search result has a first agent communication link associated with the first agent computing device and a second agent communication link associated with the second agent computing device. One or both of a first agent communication link selection and a second agent communication link selection may be received, where the first agent communication link selection being associated with the first agent communication link, and the second agent communication link selection being associated with the second agent communication link. An alternate query entered into a secondary search field of the user interface may be received from the user computing device. This causes a second search result to display on the user computing device, where the second search result contains a second communication link to a second merchant

As an option, the step of communicating the query regarding the merchant from the user computing device to the first agent computing device further includes opening a first websocket, and the step of communicating the query regarding the merchant from the user computing device to the second agent computing device further comprises opening a second websocket.

In yet another embodiment of the present system and software provides a method of facilitating communication between a user computing device and at least one of a first merchant computing device and a second merchant computing device, under control of one or more computing systems configured with executable instructions. A search query may be received from the user computing device a search query entered into a search field of a user interface. A search result is caused to display on the user computing device, the search result containing a first merchant communication link and a second merchant communication link. An indication is received that the a first merchant communication link and the second merchant communication link have been selected through the user interface. A dialog field is caused to display in the user interface for entering a merchant query. The merchant query is communicated from the user computing device to the first merchant computing device and the second merchant computing device. A first websocket is opened between the user computing device and the first merchant computing device, in which the merchant query can be communicated to the first merchant computing device and a first query response can be communicated to the user computing device. A second websocket is opened between the user computing device and the second merchant computing device, in which the merchant query can be communicated to the second merchant computing device and a second query response can be communicated to the user computing device.

Optionally, the first merchant computing device is networked or otherwise connected with a first agent computing device and a second agent computing device. The merchant query may be communicated to the first agent computing device. A first response time period is initiated, within which a first agent query response can be received from the first agent computing device. The merchant query may be communicated to the second agent computing device upon expiration of the first response time period, and thereafter a second agent query response can be received from the second agent computing device. And, at least one of the first agent query response and the second agent query response can be communicated to the user computing device. Optionally, the second merchant computing device is networked with a third agent computing device and a fourth agent computing device.

As an option, the merchant query can be communicated to the third agent computing device. A third response time period is initiated, within which a third agent query response can be received from the third agent computing device. The merchant query may be communicated to the fourth agent computing device upon expiration of the third response time period, thereafter a fourth agent query response can be received from the fourth agent computing device. And, at least one of the third agent query response and the fourth agent query response may be communicated to the user computing device.

Again, as an option, the first merchant computing device is networked with a first agent computing device and a second agent computing device, and the second merchant computing device is networked with a third agent computing device and a fourth agent computing device. A first agent websocket may be opened between the user computing device and the first merchant computing device, in which the merchant query can be communicated to the first merchant computing device and a first agent query response can be communicated to the user computing device. A second agent websocket may be opened between the user computing device and the second merchant computing device, in which the merchant query can be communicated to the second merchant computing device and a second agent query response can be communicated to the user computing device. A third agent websocket may be opened between the user computing device and the third merchant computing device, in which the merchant query can be communicated to the third merchant computing device and a third agent query response can be communicated to the user computing device. A fourth agent websocket may be opened between the user computing device and the fourth merchant computing device, in which the merchant query can be communicated to the fourth merchant computing device and a fourth agent query response can be communicated to the user computing device.

### BRIEF DESCRIPTION OF THE SEVERAL VIEWS OF THE DRAWINGS

FIG. 1 illustrates an example network, with an application server having programs encoded on computer storage devices and configured to perform at least some of the actions of the methods, and the customer and employee computing devices connected to the server or other computing means through the Internet;

FIG. 2 illustrates an exemplary graphical user interface displayed on the screen of the customer computing device, showing an example first interface for entering a search query;

FIG. 3 illustrates the exemplary graphical user interface of FIG. 2 displayed on the screen of the customer computing device, showing a second interface for selecting employees and entering and receiving communications;

FIG. 4 illustrates an exemplary graphical user interface displayed on the screen of the customer computing device, showing various store locations and routes on a map;

FIG. 5 illustrates an exemplary graphical user interface displayed on the screen of one or both of the customer and merchant computing device, showing text communications between the customer and merchant overlaid atop a map showing the location of the store from which the communication was received;

FIG. 6 depicts a flow diagram that may be performed by a server or other computing means, in accordance with one embodiment; and

FIG. 7 depicts a flow diagram that may be performed by a server or other computing means, in accordance with yet another embodiment.

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

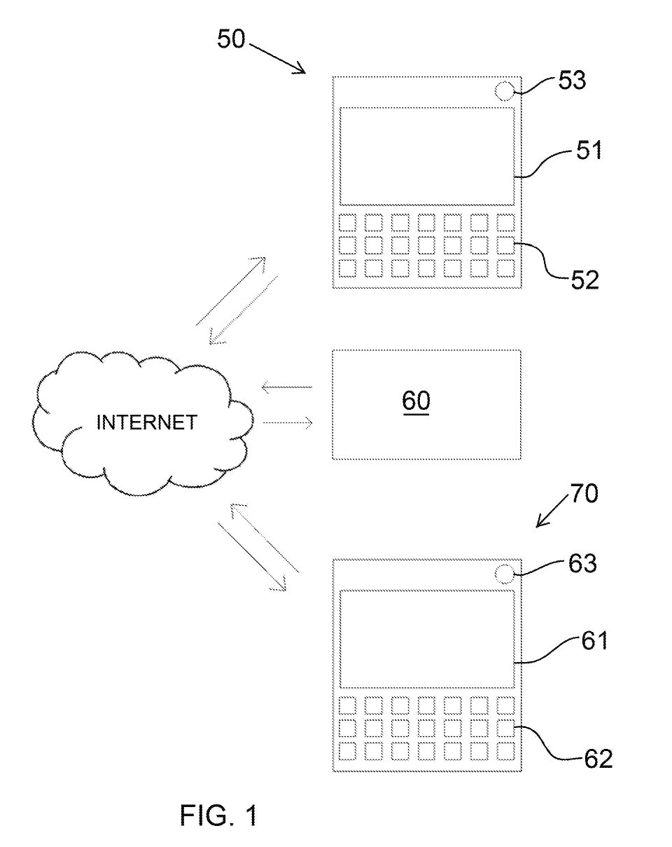

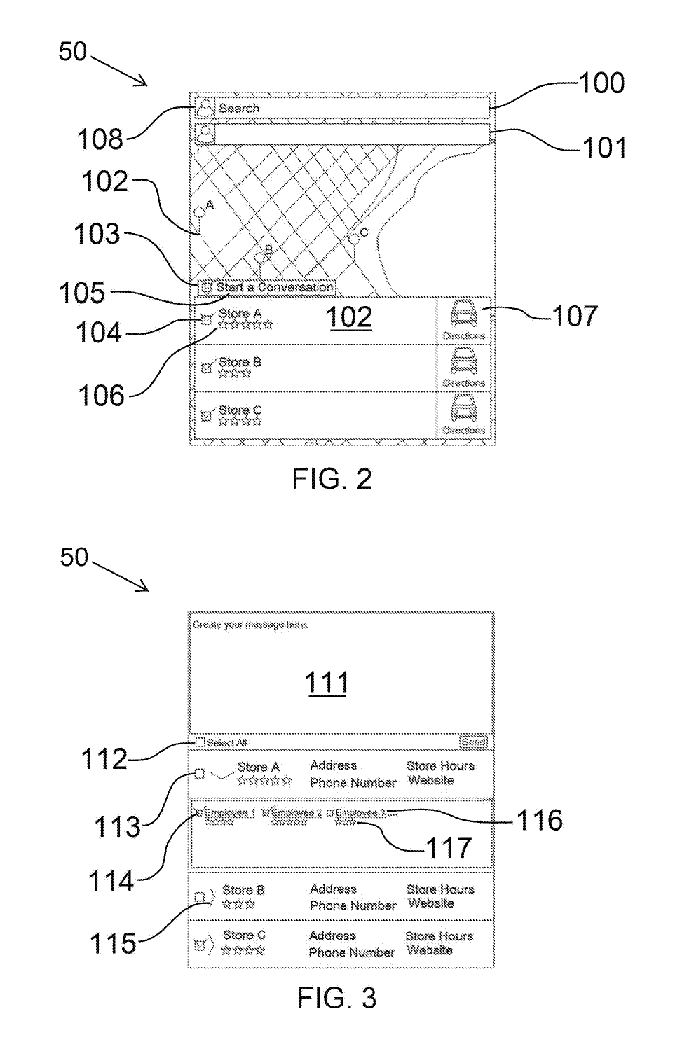

FIGS. 1 and 2 illustrate an example of a computer network with a customer computing device (50), a merchant computing device (70), and an application server (60), on which any of the methods and systems of various embodiments may be implemented. In particular, application server (60) in this example, may represent any of the computer systems and physical components necessary to perform the computerized methods discussed in connection with FIGS. 3-8 and, in particular, may represent a server, client or other computer system upon which e-commerce servers, websites, web browsers and/or web analytic applications may be instantiated. Further, one or all of the application server (60), the customer computing device (50), and the merchant computing device (70) may be encoded with executable instructions for carrying out the present method.

The illustrated exemplary application server (60) is generally known to a person of ordinary skill in the art, and may include a processor, a bus for communicating information, a main memory coupled to the bus for storing information and instructions to be executed by the processor and for storing temporary variables or other intermediate information during the execution of instructions by processor, a static storage device or other non-transitory computer readable medium for storing static information and instructions for the processor, and a storage device, such as a hard disk, may also be provided and coupled to the bus for storing information and instructions. The application server (60) may optionally be coupled to a display for displaying information. However, in the case of servers, such a display may not be present and all administration of the server may be via remote clients. Further, the server (60) may optionally include an input device for communicating information and command selections to the processor, such as a keyboard, mouse, touchpad, and the like.

The server (60) may also include a communication interface coupled to the bus, for providing two-way, wired and/or wireless data communication to and from the server (60). For example, the communications interface may send and receive signals via a local area network or other network, including the Internet.

In the present illustrated example, one or more of the hard drives of the server (60), the user computing device (50), and the merchant computing device (70) is encoded with executable instructions, that when executed by a processor cause the processor to perform acts as described in the methods and systems of FIGS. 2-5.

Looking at FIG. 1, an exemplary user or customer computing device (50) is illustrated. The customer device (50) may be one of many available computing devices capable of running executable programs and/or a browser instance. For example, the customer device (50) and the merchant device (70) may be a mobile device, such as a tablet computer or a mobile phone device with computer capabilities, a laptop, a desktop, or other computing device. Executable instructions for the present method may be installed on the server (60) that hosts a web application caused to display a user interface on one or both of the customer device (50) and the merchant device (70). Alternatively, executable instructions for at least part of the present method may be installed locally on one or both of the customer device (50) and the merchant device (70).

In a first example embodiment, the customer device (50) and the merchant device (70) access and interact with the graphical user interface through a web browser instance, such as FIREFOX, CHROME, SAFARI, INTERNET EXPLORER, and the like. The web application is hosted on an application server with application hosting capabilities. The customer device (50) may have a display (51), a keyboard (52), and a speaker (53), through which various communications and instructions may be entered and received, the website navigated. Similarly, the merchant device (70) may also have a display (61), a keyboard (62), and a speaker (63), for entering and receiving communications and instructions, and navigation. The speakers (53 and 63) may be used for emitting a notification sound (or ping) upon receipt of a communication.

The application server (60) may relay messages entered on the customer device (50) and the merchant device (70). For example, a message entered on the customer device (50) is received by the server (60) and sent to the merchant device (70), thus relaying a message from the customer to the salesperson. The customer device (50) and merchant device (70) are preferably configured to receive push notifications from the server (60) over a network, which may activate the speakers (53 and 63). To answer the query, a response is entered on the merchant device (70) by the salesperson, then received by the server (60), and sent to the customer device (50). The customer device (50) and merchant device (70) may utilize common communication protocols to send and receive data to and from the server (60), such as transmission control protocol (TCP), hypertext transfer protocol (HTTP) for browsers, user datagram protocol (UDP), and wireless application protocol (WAP) to connect to Wi-Fi networks.

Alternatively, executable instructions for carrying out at least part of the present method may be installed locally on one or both of the customer device (50) and the merchant device (70). For example, one or both of the customer device (50) and the merchant device (70) may be required to locally install an application on a smartphone device for carrying out all or part of the present method. In an example embodiment, an executable application file is installed on each of the devices (50 and 70), so that messages can be sent to and received from the server (60), with the server sending the messages to both the customer device (50) and the merchant device (70). The messages may be comprised of various forms of data, such as alpha-numeric text, pictures, links, and so on. In yet another example embodiment, one party may have an application installed on the computing device, while the other party sends and receives messages through a browser instance. For example, messages may be sent and received on the customer device (50) through a web browser instance, while the merchant device (70) utilizes a locally installed application.

FIG. 2 illustrates an example graphical user interface displayed on the customer device (50), with an interactive map interface searchable through a suitable map application programming interface (API), such as GOOGLE MAPS API. The interactive map interface has a primary search bar (100) and a secondary search bar (101). These search bars (100, 101) may prompt the customer to enter a text query or permit an alternative entry method, such as voice commands, and so on.

The primary search bar (100) may receive a broad search term, such as a specified area (zip code, county code, district code, etc.), a product or industry type (bookstores, clothing stores, outlet stores, restaurants, etc.), or search for a specific destination. The secondary search bar (101) may be hidden initially, then be displayed once the customer enters a search term within the primary search bar (100). The secondary search bar (101) may be used to receive a refined query, basically to refine the search query entered into the primary search bar (100). The search engine may combine the search query and the refined search query with appropriate search operators to obtain a desired search result.

Within either search bar (100 or 101), when searching for specific merchants, the user may enter multiple search queries and have them appear on the interactive map. As an example, the user may simultaneously enter the search terms “MACY'S”, “TARGET”, “NORDSTROM”, BLOOMINGDALES”, etc.; and all of the individual search items will populate the map concurrently. The present system uniquely enables a search for multiple stores, and displays the store locations and information on the same map interface.

For example, if the search query entered into the primary search bar (100) is a zip code; and the refined search query entered into the secondary search bar (101) is “department store”, then only department stores within the zip code will be displayed as pins on the map interface and within a list below the map interface. Yet another search bar (not shown) may appear, if the customer desires to refine the searches even further. The secondary search bar (101) may also be used to search for nearby businesses or alternate routes. A “Get Directions” command may be activated in the interface, which can be chosen for any of the search results that appear on the map. Within the search bar is a button to access each user's personalized User Profile (108). This profile will be very similar to that of FACEBOOK, GOOGLE PLUS, LINKEDIN, etc.

Search Results (102) may be illustrated as pins or symbols on an interactive map that shows the locations and a scrollable or swipe-able list of stores (102) that will populate the bottom of the screen. Each store may have a review rating (106) based upon the average customer service ratings of the employees who use the mobile/web application. Upon selecting businesses within the list (104) or selecting the select all box (103), and selecting the “Start a Conversation” button (105) an instant messaging interface and store menu is displayed with a dialog box.

A message sent by the customer through the instant messaging interface is received by the server (60) which opens up a websocket for that specific user. Application server (60) then sends the message to the merchant device (90). A websocket allows the server (60) to have multiple channels of communication over a single TCP/IP connection. The websocket allows the customer and the employees to have multiple chats with multiple users at the same time. Such effective real time relay of messages allows users and employees to communicate without any interference from the presence of other users.

Looking at FIG. 3, an example initial messaging and store menu interface screen is illustrated. A portion of the screen is a dialog box (111), into which the customer may type questions directed to one or more salespeople at one or more business locations. Specific and multiple businesses may be selected by the customer for communications. Within each business, a specific employee or salesmen may be selected. In this way, messages entered into the customer device (50) is received by the server (60), and sent to the merchant devices (70) associated with each business and each salesman at the business. For example, Employee 1 from Store A and Store B may be selected. A message entered by the customer into the dialog box (111) is sent to both Employee 1 and Store B, where one or both may respond to the message at their option, thus opening separate dialogs.

The business information for the different stores is listed, along with the store customer service rating, and a drop down list (115) of currently available store employees with their customer service rating (117) shown and profile link provided (116). The customer can choose to message the all of the stores (112), each whole store individually (113), or select individual employees at each individual store (114).

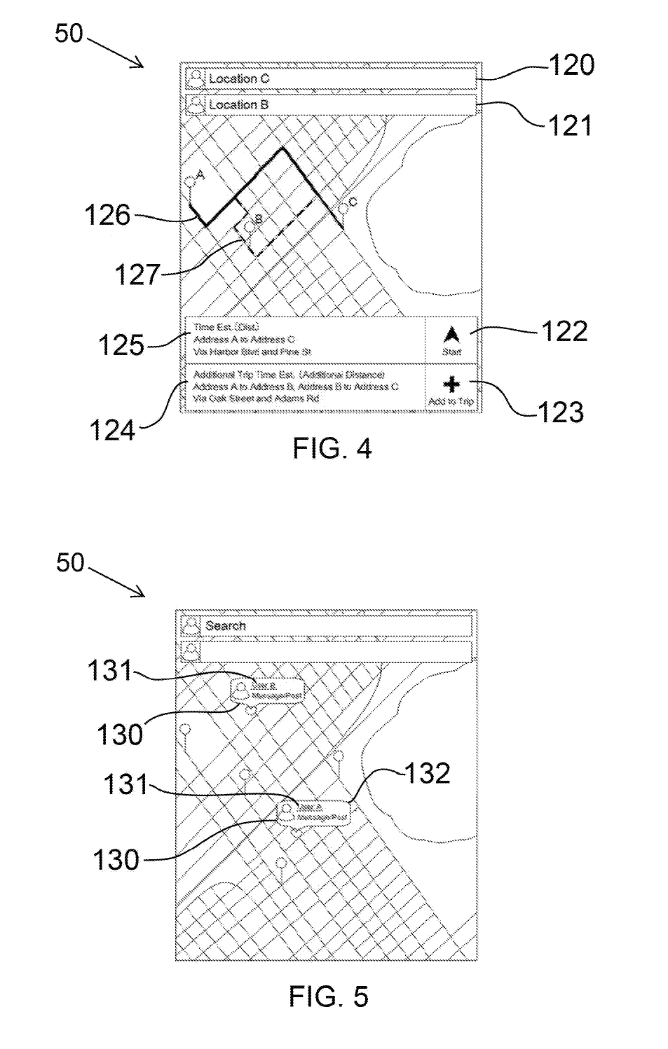

FIG. 4 illustrates an example interactive map system with a multiple destinations calculator optimizer. The multiple destinations calculator optimizer allows the customer to enter multiple destinations (123), which may be stores or other locations. For example, the customer enters a destination within the search bar (120), and receives an optimized route (126) for travel from her current location to the destination. The customer may also enter a second destination in a second search bar (121). The application calculates an optimum route (127) encompassing both destinations in a single trip. The customer can enter yet more destinations while the optimizer takes the query and outputs an optimized route with the destinations as stops. The interactive map will use graph search algorithms such as the minimum spanning tree algorithm, Dijkstra's algorithm, Prim's algorithm and other greedy search algorithms. The interactive map may be treated as a graphical tree, where the destinations entered by the customer are treated as tree nodes.

FIG. 5 illustrates an embodiment of the interactive map which permits all users to enter social posts (130), which may be displayed as text bubbles on the map interface, at a location indicated by the user or ascertained by GPS. The text bubbles may be selected and may contain a hyperlink to the user profile (131) and to an associated conversation (132). Users have the option to make social statuses similar to other popular social networking websites such as FACEBOOK, GOOGLE PLUS, TWITTER, etc. This may also be used by store employees to brand advertise their business by posting deals and related statuses on their store on the interactive map. The social posts that are displayed on the map will be related to the user's current search terms, previous searches if no current term is being searched, or other settings such as favorites, contacts, industry, subject, etc.

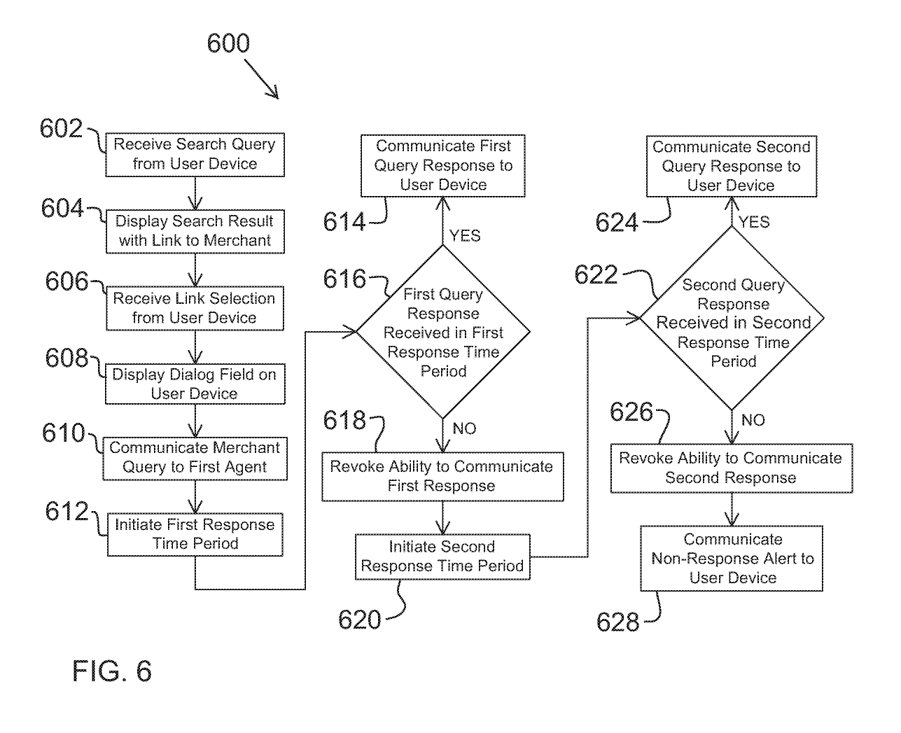

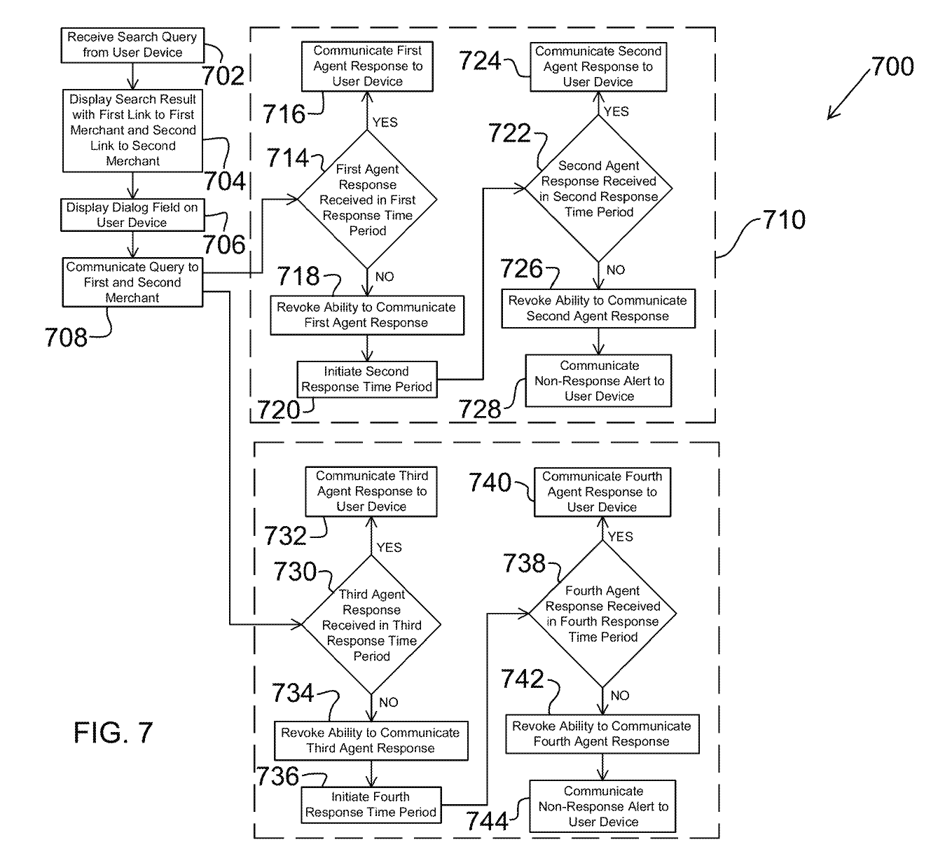

FIGS. 6 and 7 discloses a flow diagrams of the present method (600, 700) that may be performed by a server or other computing means, in accordance with one embodiment of the present method of finding stores and businesses on an interactive map and communicating with them through the process of instant messaging or other similar or known means of communications. The user or potential customer enters a search term or query into the user interface search bar (101), which is received by the server (60) (602). The user interface may be of an application installed on the customer device (50) or a website hosted by the server (60). The search results are caused to display on the customer device (50), where the store locations are shown as a list of stores and/or linked icons overlaid atop the map which permits the user to interact with the icons by clicking or otherwise selecting the icons or text to select a merchant or an agent or employee of the merchant (604). The link selection is received by the server (606). Thus, one or more stores are selected by the user (420), which opens a message dialog box or field, much like an instant messaging dialog box (608), so that the user can enter a question or comment regarding the merchant's product or service.

The user types a message in the dialog box; and now has the option to either send it to one or more merchants or stores and one or more employees or agents of the merchant by checking the appropriate boxes. The input is received by the server (60) and sent to selected merchant or agent computing devices. The merchant could be a store or other business; and the agent can be an employee, the owner, independent contractor, or anyone who operates on behalf of the merchant. When the user sends an instant message to an employee or business, a web socket channel opens to relay the messages between the user and the one or more employees or businesses. Every time a user creates a new conversation with an employee, a new web socket channel is opened by the application server. This keeps the conversations isolated from one another and avoids concurrency issues that could happen in a multi-channel communication setup. For example, a user could send a message to a first agent and a second agent (third, fourth, and so on) at the same time. With the lack of websockets there could be possible delays in sending and receiving messages as in a single channel socket.

Similar to the customer device (50), the merchant device (70) permits the agent or business owner to access the present application or website to permit communications with the customer device (50). The first agent computing device receives a message as a push notification reminder (610). When the first agent selects the notification icon, she is taken to an instant messaging system interface, similar to one on the application for the customer. The employee has the option to respond to multiple customers simultaneously. Every message that the employee receives from a unique user may open in a separate tab. This allows the employee to keep the conversations separate for each customer in a neat, organized manner. The customer has the option of closing the conversation with any particular employee, without further response from that closed employee.

Further, when a customer sends a message to one or more merchants, the message will go through a tiered, time based system that may be in-part based on the seniority or position of employees using the web application. As an example, a merchant may want the first tier to be employees who work the floor at a retail store, the second tier to be all department managers, and the third tier being the remaining highest levels of management at the retail store. The message would be sent to the next sequential tier after a predetermined amount of time has passed. For example, if the message from the customer is not indicated as received at the first tier within 60 seconds, the message is forwarded to another tier, the second tier in this example. In the illustrated diagram, step (610) is the initiation of the first response time period. If the first agent responds to the query or comment within the first response time period (616), the response is communicated to the user computing device (614). If the first agent responds to the query or comment within the first response time period (616), the ability to respond may be revoked (618). The response may also be in the form of a message that the first agent will be responding shortly. If the first agent fails to respond, a second response time period is initiated (620), where a second agent is permitted to respond in much the same way as the first agent, where the second agent's process (steps 622, 624, 626, and 628) may be identical to the first agent's process. Likewise, if is not indicated as received at the second tier, the message may be forwarded to the third tier, and so forth.

The time interval may be set by the merchant. Further, the merchant may require an actual response within the time period or just an indication by the employee that the message will be responded to by that employee. Each tier may have differing response time requirements. Additionally, if the employee is not competent to answer the message, the employee may manually forward the message to the appropriate tier or department.

A message may be displayed on the customer device (50) that indicates that the message is being forwarded to a higher level, so that the customer remains informed. In this way, the customer is not forced to wait an unreasonable amount of time before the message receives a response.

The merchant has administrative privileges to organize the seniority of the agents/employees according to a tier system. For instance, the merchant could place a group of employees working on the floor in Tier 1, managers in Tier 2, and perhaps the merchant or owner or officer in Tier 3. When a customer sends a message to any merchant, the message is first sent to Tier 1, as set by the administrator. Upon receiving this message, a preset timer, as set by the administrator, begins and will only conclude upon a response from an employee in Tier 1. Upon completion of the timer, which also suggests a lack of response from Tier 1, the message is forwarded to the employees in Tier 2. Similarly, a timer starts as soon as Tier 2 receives the message, and is forwarded to Tier 3 eventually upon countdown completion. The present system enables the creation of separate tables in the database for the tiers as set by the administrator on the admin interface. Separate tables insure that there aren't any concurrency issues among the different tiers such as multiple tiers getting the message at the same time.

FIG. 7 illustrates an exemplary method of an alternate embodiment of the present system, where a search query may be directed to a first merchant computing system (710) and a second merchant computing system (712) at or near the same time. A search query is received from the user computing device (702). A search result is displayed on the user computing device, with links to the first merchant and the second merchant (704). The links can be markers on a digital map showing the physical location of the merchant or alphanumeric links. The user may select one or both merchants (or multiple merchants if more than two are presented) with which to initiate communication. The dialog field or box is displayed on the user computing device which permits the user to enter a query (which can be a comment or question that requires a response) (706). The query is communicated to the first merchant system (710) and the second merchant system (712).

Each merchant has a tiered system as described in reference to FIG. 6, each with similar steps. With the first merchant, the first agent is given a time period to respond (714), where the response can be communicated to the user (716). Or, the first time period can expire (718), and a second response time period initiated (720). The second agent may respond to the query (722); and the response communicated to the user device (724). If no response is received from the second agent fails to respond, then the ability to respond may be revoked (726), and a message sent to the user indicated nonresponse from the first merchant (728). Alternatively, yet another agent can receive the message and given another time period in which to respond.

In a very similar manner, the second merchant's tiered system communicates the message to a third agent with a third time period (steps 730, 732, and 734). If the third agent fails to respond, a fourth time period is initiated (736), which enables a fourth agent to respond (steps 738, 740, 742, and 744). In the example illustrated in FIG. 7, four or more websockets may be opened to permit the user to communicate separately with each merchant or each agent of the merchants.

The present method and system provides a superior searchable and interactive map. Current interactive map applications lack the option to communicate directly with the employees of stores and businesses that are populated as suggestions within a search result. The present method and system solves that problem and enables the customer to avoid the hassle of contacting each store individually and directly. Although the present method and system shows “brick and mortar” business locations interactively on a map, business owners physically located outside of a map area may register to show up as a search result on a map. Thus, a plumber (or other skilled professional, who works with customers within a particular area, yet has a business outside that area, can register so that his business is shown as an icon or a link within the user interface or directly on the map image.

This application is related to U.S. provisional application No. 62/023,515 filed on Jul. 11, 2014 and to U.S. patent application Ser. No. 14/798,299 filed on Jul. 13, 2015, each of which are incorporated by reference in their entirety.

Although the present system and method has been described in considerable detail with reference to certain preferred versions thereof, other versions are possible. Therefore the spirit and scope of the appended claims should not be limited to the description of the preferred versions contained therein.

What is claimed is:

1) A system for real-time communication between multiple devices, the system comprising:
a computing system comprising a server comprising a multiple channel communications system enabling multiple simultaneous real-time channels of communication, a user computing device, a first merchant computing system and a second merchant computing system, each executing specific computer-executable instructions, and configured to at least:
communicating, from the server utilizing the multiple channel communications system, a product query received from the user computing device to the first merchant computing system in a first channel of communication and simultaneously to the second merchant computing system in a second channel of communication, the first merchant computing system comprising a first agent computing device and a second agent computing device, the second merchant computing system comprising a third agent computing device and a fourth agent computing device;
establishing the first channel of communication between the user computing device and the first merchant computing system, comprising;
initiating a first response time period, within which a first query response can be received from the first agent computing device;
revoking communication from a first agent computing device when the first response time period expires; and
communicating the query to the second agent computing device upon expiration of the first response time period, thereafter a second query response can be received from the second agent computing device;
establishing the second channel of communication between the user computing device and the second merchant computing system, comprising;
initiating a third response time period, within which the first query response can be received from the third agent computing device; and
revoking communication from the third agent computing device when the third response time period expires;
communicating the query to the fourth agent computing device upon expiration of the third response time period, thereafter a second query response can be received from the second agent computing device.
